(19) United States
(12) Patent Application Publication
(10) Pub. No.: US 2023/0129855 A1
(43) Pub. Date: Apr. 27, 2023

(54) COOLING DEVICE AND METHOD FOR MANUFACTURING COOLING DEVICE

(71) Applicant: HONDA MOTOR CO., LTD., Tokyo (JP)

(72) Inventors: Hirosumi TODAKA, Saitama (JP); Yasunari KIMURA, Saitama (JP)

(21) Appl. No.: 17/938,333

(22) Filed: Oct. 6, 2022

(30) Foreign Application Priority Data
Oct. 21, 2021 (CN) 202111227331.5

(51) Int. Cl. F01P 3/02

(52) U.S. Cl. CPC F01P 3/02; F01P 2003/021

(57) ABSTRACT

A cooling device includes a cooling solution flow path disposed in the surroundings of a heat generating portion and formed of a metal material. The cooling solution flow path has a three-dimensional structure element having a structure in which unit elements made of the metal material are regularly aligned therein. The three-dimensional structure element is continuously provided on an inner wall surface of the cooling solution flow path.

This application is based on and claims the benefit of priority from Chinese Patent Application No. 202111227331.5, filed on 21 Oct. 2021, the content of which is incorporated herein by reference.

### BACKGROUND OF THE INVENTION

### Field of the Invention

The present invention relates to a cooling device and a method for manufacturing a cooling device.

### Related Art

An engine block of an engine for a vehicle is provided with a water jacket having a cooling solution flow path.

In the related art, providing a partitioning wall or a rib inside the cooling solution flow path of the water jacket is known (see Patent Documents 1 to 3, for example).
Patent Document 1: Japanese Unexamined Patent Application, Publication No. S60-17255
Patent Document 2: Japanese Unexamined Utility Model Application, Publication No. S59-52123
Patent Document 3: Japanese Unexamined Utility Model Application, Publication No. 362-43127

### SUMMARY OF THE INVENTION

However, if the partitioning wall or the rib is provided inside the cooling solution flow path, there is a problem that a smooth flow of the cooling solution is impaired and there is a concern that heat exchanging performance is degraded.

Also, a lamination forming method of lamination-forming a product in a three-dimensional manner by using a 3D printer has been known in recent years. According to the lamination forming method, it is possible to easily mold a metal product with a more complicated structure than that of a casting method, by using a metal material such as powder metal or a metal wire.

However, in a case in which a metal product having a hollow part such as a cooling solution flow path therein is lamination-formed, the hollow part is likely to be deformed during the formation. Therefore, it is necessary to perform the formation with a limitation to a posture that does not cause deformation of the hollow part, and there is a problem that a degree of freedom in design is limited. Moreover, although a support member for preventing deformation may be integrally molded inside the hollow part in order to improve the degree of freedom in design while preventing deformation of the hollow part during formation, it is necessary to remove the support member after the formation, and there is a problem that this may lead to an increase in number of processes and degradation of quality.

An object of the present invention is to provide a cooling device capable of improving heat exchange performance of a cooling solution flow path without significantly impairing a smooth flow of a cooling solution and to provide a method for manufacturing a cooling device that enables efficient manufacturing of a cooling device with improved heat exchange performance of a cooling solution flow path without any need to remove a support member provided in the cooling solution flow path.

(1) A cooling device according to the present invention is a cooling device (for example, a water jacket 2 which will be described later) including: a cooling solution flow path (for example, a cooling solution flow path 21 which will be described later) disposed in surroundings of a heat generating portion (for example, a cylinder liner 11 which will be described later) and formed of a metal material, the cooling solution flow path including a three-dimensional structure element (for example, a lattice group 3 which will be described later) having a structure in which unit elements (for example, lattice structures 31 which will be described later) made of the metal material are regularly aligned therein, and the three-dimensional structure element is continuously provided on an inner wall surface (for example, an inner wall surface 211 which will be described later) of the cooling solution flow path.

(2) A method for manufacturing a cooling device according to the present invention is a method for manufacturing a cooling device (a water jacket 2 which will be described later) that includes a cooling solution flow path (for example, a cooling solution flow path 21 which will be described later) disposed in surroundings of a heat generating portion (for example, a cylinder liner 11 which will be described later) and formed of a metal material, the method including: continuously providing a three-dimensional structure element (for example, a lattice group 3 which will be described later) having a structure in which unit elements (for example, lattice structures 31 which will be described later) made of the metal material are regularly aligned from one surface (for example, one surface 211a which will be described later) to another surface (for example, the other surface 211b which will be described later) of an inner wall surface (for example, an inner wall surface 211 which will be described later) of the cooling solution flow path inside the cooling solution flow path and thereby lamination-forming the cooling device by the metal material while causing the three-dimensional structure element to function as a support member.

According to (1) described above, the three-dimensional structure element continuously provided on the inner wall surface of the cooling solution flow path increases the heat conducting area of the cooling solution flow path. The three-dimensional structure element having the structure in which the unit elements are regularly aligned enables the cooling solution to be distributed therethrough and does not significantly impair a smooth flow of the cooling solution, and heat exchanging performance of the cooling solution flow path is thus improved.

According to (2) described above, the three-dimensional structure element can be used as a support member for preventing deformation of the cooling solution flow path at the time of the formation, the formation posture of the cooling device is thus not limited, and it is possible to improve a degree of freedom in design of the cooling device. It is not necessary to remove the three-dimensional structure element from the inside of the cooling solution flow path after the formation, and it is possible to easily construct the cooling solution flow path with a heat conducting area increased by the three-dimensional structure element. Therefore, it is possible to efficiently manufacture a cooling device in which heat exchanging performance of the cooling solution flow path is improved by the three-dimensional structure element.

### BRIEF DESCRIPTION OF THE DRAWINGS

FIG. 1 is a perspective view of an engine block having a cooling device;

FIG. 2 is a vertical sectional view of the engine block illustrated in FIG. 1;

FIG. 3 is a diagram illustrating a section along the line A-A in FIG. 2 in an enlarged manner;

FIG. 4 is a perspective view illustrating a lattice structure at the portion B in FIG. 3 in an enlarged manner;

FIG. 5 is a perspective view illustrating how the engine block illustrated in FIG. 1 is lamination-formed; and

FIG. 6 is a vertical sectional view of a rotation motor having a cooling device.

### DETAILED DESCRIPTION OF THE INVENTION

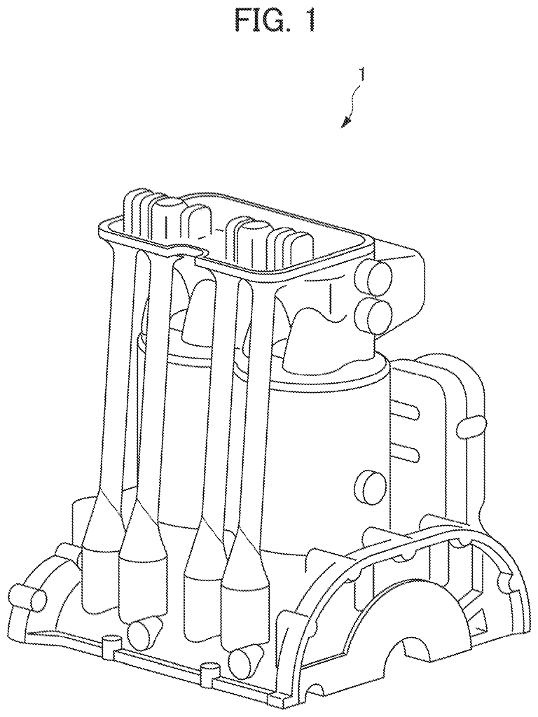

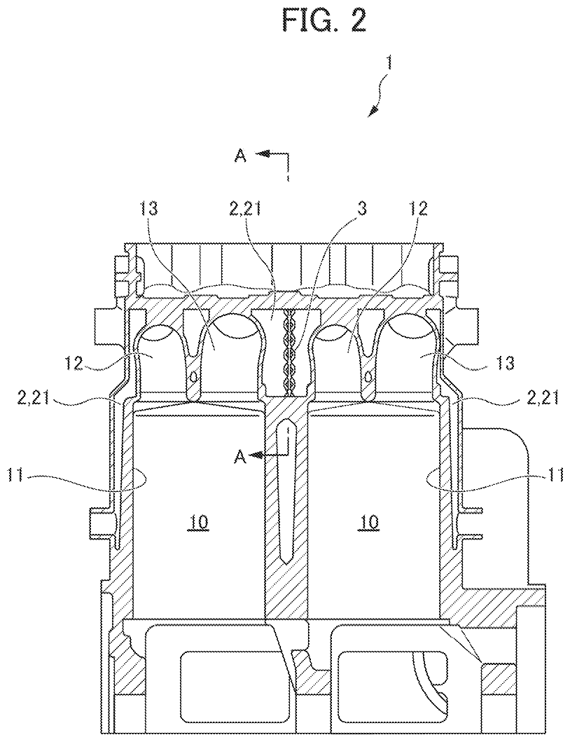

Hereinafter, an embodiment of the present invention will be described with reference to the drawings. FIGS. 1 and 2 illustrate an engine block 1. Only a part of the engine block 1 having two cylinder bores 10 and 10 from among a plurality of cylinder bores provided in an engine that serves as a power unit is illustrated.

As illustrated in FIG. 2, the engine block 1 has cylinder liners 11 and 11 constituting the two cylinder bores 10 and 10, an intake port 12 and an exhaust port 13 that communicate with the cylinder bores 10 and 10, respectively, and a water jacket. 2 therein. The engine block 1 is an integrally molded article that is integrally molded using a metal material such as an aluminum-based material with satisfactory heat conductivity, for example.

In the engine block 1, the cylinder liners 11 are heat generating portions that generate heat when the engine is driven. Therefore, the surroundings of the cylinder liners 11 are cooling target. The water jacket 2 is a cooling device that is provided in the surroundings of the cylinder liners 11, the intake port 12, and the exhaust port 13 and cools, with a cooling solution, the surroundings of the cylinder liners 11 including the intake port 12 and the exhaust port 13.

The water jacket 2 has a cooling solution flow path 21 constituted by a hollow surrounding the cylinder liners 11, the intake port 12, and the exhaust port 13. A lattice group 3 is provided inside the cooling solution flow path 21. The lattice group 3 is constituted by a plurality of lattice structures 31 made of the same metal material as the metal material forming the engine block 1. The lattice group 3 in the present embodiment has a three-dimensional structure element having a structure in which the lattice structures 31 that are unit elements made of the metal material are regularly aligned in a three-dimensional direction. The lattice group 3 is configured by the plurality of lattice structures 31 that are unit elements being coupled to each other. A space through which the cooling solution can be distributed is formed between the adjacent lattice structures 31 and 31.

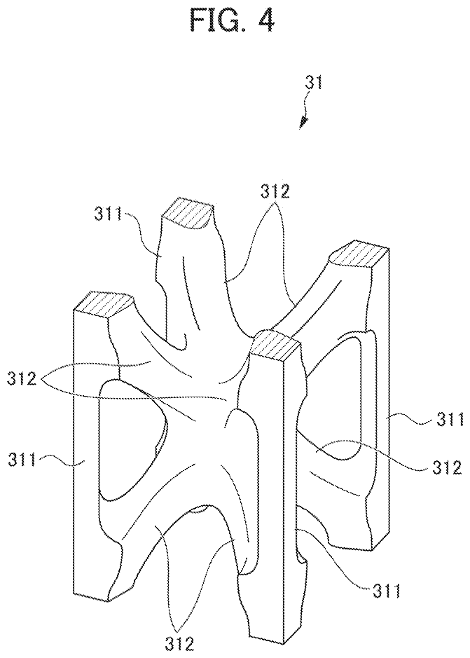

The lattice structures 31 are unit elements with three-dimensional lattice shapes branched into branch shapes. The lattice structures 31 in the present embodiment have a plurality of columnar portions 311 and a plurality of oblique portions 312 as illustrated in FIG. 4. A plurality of spaces through which the cooling solution can be distributed are formed between the plurality of columnar portions 311 and the plurality of oblique portions 312, respectively. The columnar portions 311 extend in parallel in one direction. The oblique portions 312 extend to obliquely intersect the columnar portions 311. The plurality of oblique portions 312 intersect each other. However, the lattice structures provided inside the cooling solution flow path 21 may be any three-dimensional structures as long as the three-dimensional structures are split into branches and a cooling solution can be distributed inside the lattice structures and are not limited to the lattice structures illustrated in the drawing.

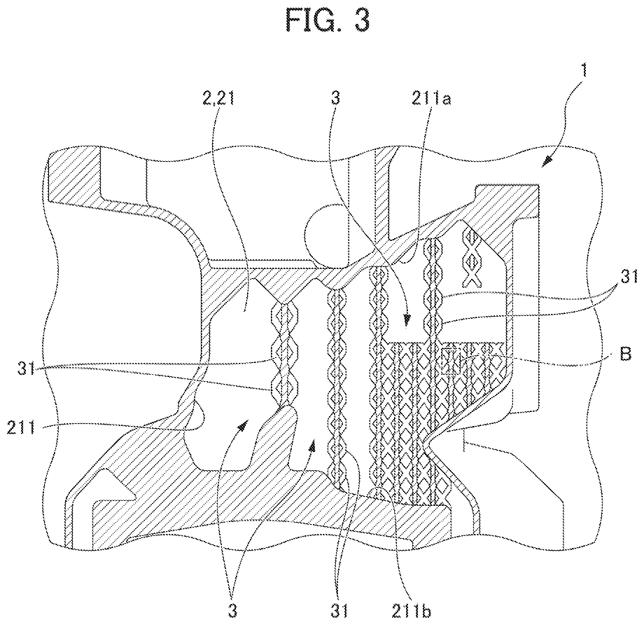

The lattice group 3 is configured by the plurality of lattice structures 31 being coupled along an extending direction (the up-down direction in FIGS. 3 and 4) of the columnar portions 311. A plurality of lattice groups 3 may be aligned to be adjacent to each other in a direction that perpendicularly intersects the extending direction of the columnar portions 311 in the lattice structures 31. A plurality of blocks of lattice groups 3 may be provided inside the cooling solution flow path 21.

The lattice group 3 is continuously provided on an inner wall surface 211 of the cooling solution flow path 21. Specifically, at least a part of the lattice group 3 is molded integrally with the inner wall surface 211 such that the part is in contact with the inner wall surface 211 of the cooling solution flow path 21. In this manner, the lattice group 3 is thermally connected to the inner wall surface 211 of the cooling solution flow path 21. The water jacket 2 leads to an increase in a heat conducting area of the cooling solution flow path 21 due to the lattice group 3. The lattice group 3 in which the plurality of lattice structures 31 are coupled enables the cooling solution to be distributed between the adjacent columnar portions 311 and 311, between the adjacent oblique portions 312 and 312, and between the adjacent columnar portions 311 and the oblique portions 312. Thus, heat exchanging performance of the cooling solution flow path 21 is improved without significantly impairing a smooth flow of the cooling solution.

The lattice group 3 in the present embodiment is continuously provided from one surface 211a to the other surface 211b of the inner wall surface 211 of the cooling solution flow path 21 as illustrated in FIG. 3. Specifically, one end of the lattice group 3 is molded integrally with the one surface 211a such that the one end is in contact with the one surface 211a of the inner wall surface 211 of the cooling solution flow path 21. The other end of the lattice group 3 is molded integrally with the other surface 211b such that the other end is in contact with the other surface 211b of the inner wall surface 211 of the cooling solution flow path 21.

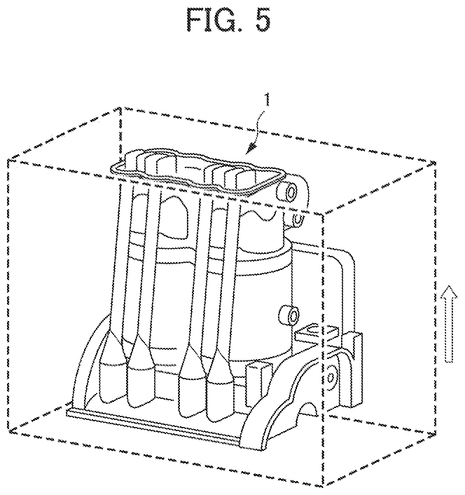

The engine block 1 made of such an integrally molded article can be obtained by lamination forming based on a lamination forming method using a metal material (metal powder, a metal wire, or the like) such as aluminum-based material with satisfactory heat conductivity by using a 3D printer. If powder metal is used as the metal material, for example, in the lamination forming method (additive manufacturing) using a 3D printer, a process of melting and solidifying a formed portion by irradiating the powder metal spread on a base plate with a laser or an electronic beam that is a heat source and a process of spreading new powder metal by moving the base plate are repeated along the direction illustrated by the arrow in FIG. 5, for example, and the engine block 1 having the water jacket 2 is thereby three-dimensionally lamination-formed.

At this time, the lattice group 3 in which the plurality of lattice structures 31 made of the metal material are coupled is continuously formed from the one surface 211a to the other surface 211b of the inner wall surface 211 of the cooling solution flow path 21 inside the cooling solution flow path 21 of the water jacket 2 provided in the engine block 1. Therefore, the water jacket 2 is lamination-formed while the lattice group 3 is made to function as a support member.

It is thus possible to use the lattice group 3 integrally molded when the cooling solution flow path 21 that is a hollow is formed, as a support member for preventing deformation of the cooling solution flow path 21. Therefore, the formation posture of the engine block 1 is not limited to the posture illustrated in FIG. 5, and a degree of freedom in design is improved. It is not necessary to remove the lattice group 3 from the inside of the cooling solution flow path 21 after the formation, and it is possible to easily construct the cooling solution flow path 21 with a heat conducting area increased by the lattice group 3. Therefore, it is possible to efficiently manufacture the water jacket 2 in which the heat exchanging performance of the cooling solution flow path 21 is improved by the lattice group 3, in the engine block 1.

Note that the one surface and the other surface of the inner wall surface 211 of the cooling solution flow path 21 are not limited to the two surfaces disposed to face each other out of the inner wall surface 211 of the cooling solution flow path 21. The one surface and the other surface of the inner wall surface 211 of the cooling solution flow path 21 may be two surfaces that are in contact with each other of the cooling solution flow path 21.

In short, the water jacket 2 according to the present embodiment has the following effects. The water jacket 2 that is a cooling device according to the present embodiment is a cooling device that includes a cooling solution flow path 21 disposed in the surroundings of the cylinder liner 11 that is a heat generating portion in the engine block 1 and formed of the metal material. The cooling solution flow path 21 includes the lattice group 3 (three-dimensional structure element) having a structure in which the lattice structures 31 (unit element) made of the metal material are regularly aligned therein. The lattice group 3 is continuously provided on the inner wall surface 211 of the cooling solution flow path 21. According to this, the lattice group 3 increases the heat conducting area of the cooling solution flow path 21. The lattice group 3 enables the cooling solution to be distributed between the adjacent lattice structures 31 and 31 and does not significantly impair a smooth flow of the cooling solution, and the heat exchanging performance of the cooling solution flow path 21 is thus improved.

The method for manufacturing the water jacket 2 according to the present embodiment is a method for manufacturing the water jacket 2 that is the cooling device that includes the cooling solution flow path 21 disposed in the surroundings of the cylinder liner 11 that is a heat generating portion in the engine block 1 and formed of the metal material. The lattice group 3 is lamination-formed using the metal material while the lattice group 3 is made to function as a support member by continuously providing the lattice group 3 (three-dimensional structure element) having a structure in which the lattice structures 31 (unit elements) made of the metal material are regularly aligned from the one surface 211a to the other surface 211b of the inner wall surface 211 of the cooling solution flow path 21 inside the cooling solution flow path 21. According to this, it is possible to use the lattice group 3 as a support member for preventing deformation of the cooling solution flow path 21 at the time of the formation, the formation posture is thus not limited, and it is possible to improve a degree of freedom in design. It is not necessary to remove the lattice group 3 from the inside of the cooling solution flow path 21 after the formation, and it is possible to easily construct the cooling solution flow path 21 with the heat conducting area increased by the lattice group 3. Therefore, it is possible to efficiently manufacture the water jacket 2 in which the heat exchanging performance of the cooling solution flow path 21 is improved by the lattice group 3.

Although the lattice group 3 in which the plurality of lattice structures 31 are coupled has been exemplified as the three-dimensional structure element having the structure in which unit elements are regularly aligned in the above embodiment, the three-dimensional structure element having the structure in which the unit elements are regularly aligned is not limited to the lattice group 3. The three-dimensional structure element having the structure in which the unit elements are regularly aligned may be a gyroid structure element in which a plurality of minimal surfaces are coupled in three directions, for example.

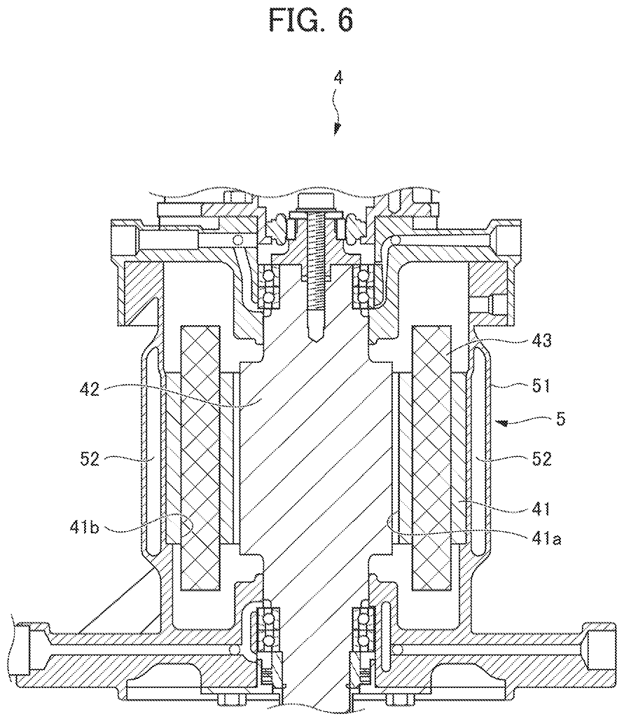

Although the water jacket 2 provided in the engine block 1 of the engine has been exemplified as a cooling device in the above embodiment, the cooling device may be any cooling device as long as it includes a cooling solution flow path that cools a heat generating portion that is a cooling target and is not limited to the water jacket provided in the engine block 1 of the engine. For example, the cooling device may be a water jacket 5 provided in a rotation motor 4 that serves as a power unit as illustrated in FIG. 6.

The rotation motor 4 includes a substantially cylindrical stator core 41 extending in an axial direction and a rotor 42 that is rotatably supported by a shaft hole 41a of the stator core 41. The stator core 41 is formed of an iron-based metal material, and coils 43 are accommodated inside a plurality of slots 41b.

Once the rotation motor 4 is driven, heat of the coils 43 is transmitted to the stator core 41, and the stator core 41 generates heat. The water jacket 5 cools the coils 43 via the stator core 41. In the present embodiment, the stator core 41 is a heat generating portion that is a cooling target of the water jacket 5.

The water jacket 5 is disposed outside the stator core 41 in the rotation motor 4 in the radial direction. The water jacket 5 includes a housing 51 disposed at the outer periphery of the stator core 41 and a cooling solution flow path 52 provided inside the housing 51 and allowing a cooling solution for cooling the stator core 41 to pass therethrough. A lattice group (not illustrated) that is similar to that described above is integrally provided inside the cooling solution flow path 52.

The water jacket 5 also has effects that are similar to those of the above water jacket 2 by integrally lamination-forming the housing 51, the cooling solution flow path 52, and the lattice group (not illustrated) using an aluminum-based metal material with satisfactory heat conductivity.

### EXPLANATION OF REFERENCE NUMERALS

2 Water jacket (cooling device)
21 Cooling solution flow path
211 Inner wall surface
211a One surface
211b Other surface
3 Lattice group (three-dimensional structure element)
31 Lattice structure (unit element)
41 Stator core (heat generating portion)
11 Cylinder liner (heat generating portion)
5 Water jacket (cooling device)
52 Cooling solution flow path

What is claimed is:

1. A cooling device comprising:
a cooling solution flow path disposed in surroundings of a heat generating portion and formed of a metal material,
wherein the cooling solution flow path includes a three-dimensional structure element having a structure in which unit elements made of the metal material are regularly aligned therein, and
the three-dimensional structure element is continuously provided on an inner wall surface of the cooling solution flow path.

2. A method for manufacturing a cooling device that includes a cooling solution flow path disposed in surroundings of a heat generating portion and formed of a metal material, the method comprising:
continuously providing a three-dimensional structure element having a structure in which unit elements made of the metal material are regularly aligned from one surface to another surface of an inner wall surface of the cooling solution flow path inside the cooling solution flow path and thereby lamination-forming the cooling device by the metal material while causing the three-dimensional structure element to function as a support member.
